(19) United States
(12) Patent Application Publication
(10) Pub. No.: US 2008/0148285 A1
(43) Pub. Date: Jun. 19, 2008

(54) Structuring Library For Developing Man-Machine Interfaces

(75) Inventors: Philippe Fournies, Clamart (FR); Emmanuel Grivot, Cachan (FR)

Correspondence Address: LOWE HAUPTMAN & BERNER, LLP, 1700 DIAGONAL ROAD, SUITE 300, ALEXANDRIA, VA, 22314, US

(73) Assignee: THALES, Neuilly-Sur-Seine (FR)

(21) Appl. No.: 11/722,565

(22) PCT Filed: Dec. 21, 2005
(86) PCT No.: PCT/EP2005/057024

§ 371 Date: Jun. 22, 2007

(30) Foreign Application Priority Data
Dec. 22, 2004 (FR) 04 13740

(51) Int. Cl. G06F 9/44; G06F 3/00

(52) U.S. Cl. 719/316; 715/762

(57) ABSTRACT

The structuring library of the invention is based on components for developing man-machine interfaces for command and control information systems comprising computer hardware, an operating system, and an execution environment for the development platform, and this library comprises, between the execution environment and the specific man-machine interface application, a technical layer grouping together an arrangement of non-specialized technical components in the application domain of said systems, each dedicated to an elementary task, their assembly providing the nonfunctional services to the application, and an application domain layer grouping together an arrangement of software components of the application domain, their assembly providing the functional services to the application, the whole serving as a basis for the MMI application considered.

The present invention pertains to a structuring library (“Framework”) for developing man-machine interfaces (MMI or HCl: “Human Computer Interface”).

Current man-machine interfaces very often comprise a large amount of hidden software code. It is generally considered that about 20% of application code is visible to the user, the remaining 80% correspond to hidden code (including in particular the technical supervision of events, services, “push/pull” data notifications (management of collections, “proxys”—which are local images of remote objects -, data transformations such as object-object projection, also termed “mapping”, etc.).

Man-machine interface developers design applications by investigating their structure or architecture, taking dynamic events into account and implementing the specified functions. MMIs receive their qualification after having been subjected to various tests.

Under these conditions, developers have to solve several problems, in particular:

The choice of an architecture, which has repercussions on the whole of the application.

The ability to handle dynamic events, on which the upgradability (or the extensibility) of the interface depends.

The functional services offered, on which the satisfaction of the client depends.

The ergonomic choices.

The concept of a structuring library was invented to help developers solve their problems. A structuring library is generally intended to solve a specific problem domain. Usually, structuring libraries are technically oriented (on the basis of technical questions, persistence questions, etc.). Certain structuring libraries, available in the form of readily obtainable “COTS” ( “Commercial Off The Shelf” ) products, make it possible to build command and control applications (in English: “CCIS”, i.e.: “Command & Control Information System”), such as for example the products “OpenMap”, “Debrief”, etc. Such structuring libraries offer a solution when the architecture of the system intended to receive them is well defined. All the functionalities provided are then integrated to form a complete application. A plug-in technique allows a developer to insert his own processes. Such possibilities of extension must have been allowed for during the design of the structuring library. The complete integrated application cannot operate when entire functions have been replaced. A developer can only customize the application using these predefined extensions. Furthermore, with these known structuring libraries, when the developer wishes to replace an entire function, the application can no longer operate correctly.

The present invention is aimed at a structuring library for developing man-machine interfaces which is upgradable and open, that is to say capable of accommodating third-party software elements, in particular but not exclusively “COTS” elements, with a view to offering new services and/or so as to be able to be updated when new products appear which will replace the similar products used if they are more efficacious than the latter, doing so without modifying the whole structure of the application and without impacting on the other elements of the structure.

The library in accordance with the invention is a library based on components for developing MMIs for command and control information systems comprising hardware, an operating system, and an execution environment for the development platform and it is characterized in that it comprises a technical layer grouping together an arrangement of non-specialized technical components in the application domain of said systems, each dedicated to an elementary task, their assembly providing the nonfunctional services to the application, and an application domain layer grouping together an arrangement of software components of the application domain, their assembly providing the functional services to the application, the whole serving as a basis for the MMI application considered.

The present invention will be better understood on reading the detailed description of an embodiment, taken by way of nonlimiting example and illustrated by the appended drawing, in which:

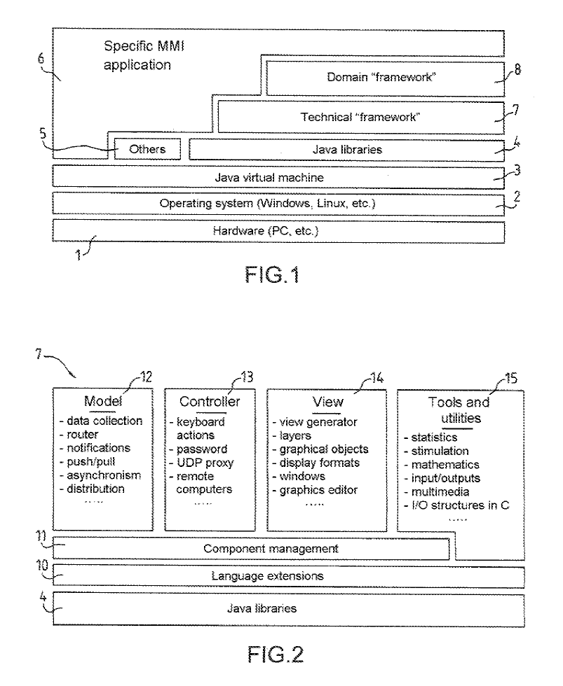

FIG. 1 is a simplified block-diagram of an information system comprising the structuring library of the invention,

FIG. 2 is a simplified block-diagram of an exemplary embodiment of the technical layer of the structuring library of FIG. 1,

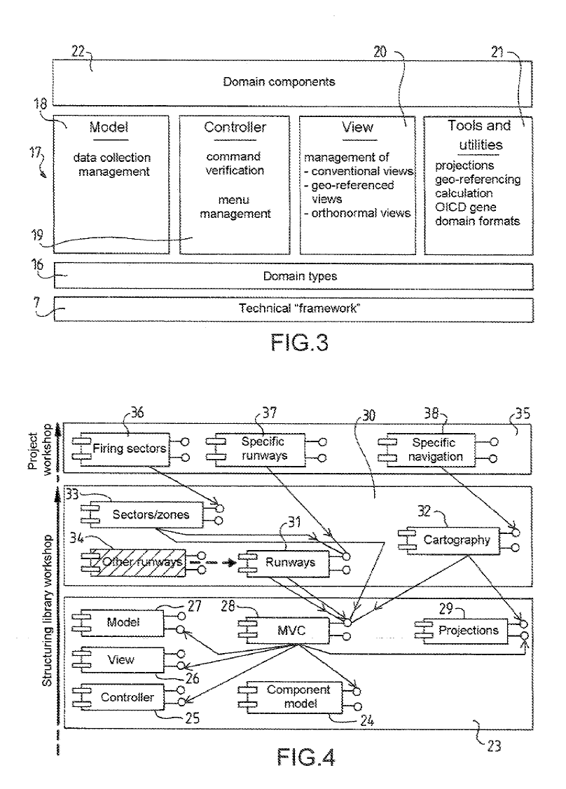

FIG. 3 is a simplified block-diagram of an exemplary embodiment of the application domain layer of the structuring library of FIG. 1, and

FIG. 4 is a block-diagram of an exemplary component-by-component development process, with a view to temporarily replacing at least one component of the library of FIG. 1 for a particular application.

The structuring library of FIG. 1 is a development and integration infrastructure for producing MMIs on a Java platform. It essentially comprises the following elements which are known per se and represented in the form of a stack of intercommunicating layers: a “hardware” part 1 (for example a PC, etc.), an operating system 2 (Windows, Unix, Linux, etc.), a Java virtual machine 3, which is a conventional COTS known as “Java run-time”. This is the implementation of an abstraction of the set of services of the operating system, thereby allowing the application to be independent of this operating system. This machine 3 communicates at one and the same time with one or more Java libraries 4, one or more additional libraries 5 in COTS form, and a specific MMI application 6. The Java libraries 4, also dubbed Java APIs (Application Programming Interfaces), cover the domains of graphics, networks, access to databases, etc. The additional libraries 5 are generally COTSs, and pertain, for example, to the domains of XML-format data management, persistence libraries, cartography, etc.

According to the invention, these elements 1 to 6 are combined with a technical layer 7 and with a layer 8 specific to the domain of the MMI application considered. The layer 7 communicates with the elements 4 and 6, while the layer 8 communicates with the elements 6 and 7.

The technical layer 7 is of graphical “middleware” type (intermediate layer). It extends the possibilities of the Java interfaces (APIs), which are therefore no longer dependent on the application domain, and takes the form of a development and integration infrastructure for building MMI applications in very diverse domains such as those relating to banks, insurance, medical equipment, aviation, etc. This layer, described in greater detail below with reference to FIG. 2, essentially comprises a software-component container, technical services and generic components. These services and components provide in particular the following so-called “nonfunctional” services: management of component execution cycles, connections between components, notification of events, management of asynchronism, persistence of parameters, generic database whose events can be notified, multi-task management, inter-task communication, management of data collections, management of the graphical layer, etc.

The layer 8 comprises generic software components which are, however, more specific than those of the layer 7. This layer, described in greater detail below with reference to FIG. 3, essentially comprises an inter-domain part common to several different applications, and parts specific to each of the main application domains. It provides so-called “functional” services such as geo-referenced display, alphanumeric display, all the functions related directly to the application domain, management of multimedia outputs, etc.

In the case of a radar application, this layer comprises components such as a generic table of runways, a generic runway display function, a cartographic display function, etc.

Represented in FIG. 2 is an exemplary embodiment of the technical layer 7. This layer constitutes a development and integration infrastructure making it possible to build MMI applications in very diverse domains: banking, insurance, medical equipment, large industrial systems, etc.

The layer 7 relies on the sub-layer 4 of Java libraries, comprising data collections, graphical interfaces Swing, AWT, Java Beans, Java 2D, Reflection, Serialization, etc. Above the sub-layer 4 is a sub-layer 10 of language extensions such as “enum” (enumerated), “ranged” (bounded values), “variant” (variables), “recyclable” (reusable values), this sub-layer 10 being surmounted by a sub-layer 11 for managing components (components being taken here in its conventional sense in this context of elementary tasks), these components being the components 12 to 14 described below. The architecture of these components is a pattern of the type, known per se, termed MVC (“Model—View—Controller”). The manager 11, also called a “component container”, accommodates these components during the execution of the application and offers them technical services as regards connections, notification of events, persistence of their parameters, etc.

The component 12, of “Model” type, comprises the following functions: data collection, router, notification of events, “push-pull” of client side data ( searching for data or receiving them), management of asynchronism, distribution, etc. The component 13 is of the “Controller” type. It manages the following functions: actions (of the user on the peripherals such as a keyboard), passwords, UDP “proxys” (“proxy” being a representation of an entity such as a computer), remote computers, etc. The “View” component 14 comprises the following functions: view generator, layer management, graphical objects, display formats, window management, graphical editor. The component 15 bundles together the tools and utilities functions, in particular statistics, stimulation, mathematical calculations, input/output management, multimedia management, input/output structures in C, etc.

FIG. 3 schematically represents an exemplary embodiment of the domain layer 8. As already indicated, this layer rests on the technical layer 7, and it comprises: a layer 16 for managing components, which in the present case are collections of data relating to the domains considered. In the radar domain, taken as an example in the present description, these data may relate for example : to tracks (for tracking of moving objects), to blips (radar echos), to distance markers, to the compass rose, to cartography, to operator aids (calculation of the closest point of approach, termed “CPA”, to course to steer calculation, termed “CTS”), to operator alerts, to various operating modes of the consoles, to equipment zones and sectors, to radar video, etc.

The layer 16 of domain types communicates with a layer 17, also of the “MVC” type mentioned above and comprising “model” components 18, “controller” components 19, “view” components 20 and “tools and utilities” components 21. Each of the types of components of the layer 16 is implemented with a model 18, at least one view 19 and one controller 20.

The “model” component 18 is a component for managing a collection of data for the identified domain that may be implemented. The “controller” component 19 essentially comprises services for verifying the commands traveling through the layer 8 and services for managing the menus of the functions provided by the components of the “domain components” layer 22 which is overlayed on the whole set of components of the layer 17. The “view” component 20 comprises in particular the services for managing “conventional” views, for managing geo-referenced views, and for managing orthonormal views. The “tools and utilities” component 21 comprises in particular the following services: graphical projections, geo-referencing calculation, “OICD” (“Operator Interface Control Document”) generator, management of formats of the identified domain, etc.

The layer 22 of components specific to a domain comprises, in the present example, the following components: management of radar video, “circles” (a technique relating to PPI-type display), acknowledgments of the operator's commands, runways, maps, blips, sectors, alerts, console operating modes, lock-on and selection function, and operator aids such as “CPA” (Closest Point of Approach), “CTS” (Course To Steer), etc.

FIG. 4 illustrates, in a very simplified manner, an advantageous development process for the structuring library of the invention. This figure illustrates, from bottom to top, the various successive steps in the development of an MMI application. Represented at 23 is the technical layer, which comprises, in the present case, and in a nonlimiting manner, the following six components: a component model 24, components 25 to 27 which are respectively of the model, view and controller type (analogous to the components 12 to 14), an “MVC” component 28 and a component 29 which here is a graphical projection management component. The component 28 is functionally linked with all the other components of this layer. The functional links between components of FIG. 4 are each symbolized by an arrow. This arrow indicates that the component from which the arrow departs needs what the arrow is pointing at.

At the next step of the development, the components of the domain layer 30, similar to the layer 8, are added. These components are, in the present example, the following: a component 31 for managing runways, a cartography management component 32 and a component 33 for managing radar zones and sectors. In the case of a change of domain or a significant modification of the management of a domain, the invention makes it possible to temporarily or definitively replace a component which is no longer appropriate to this new use with an appropriate component. In the example represented in the drawing, when the nature of the managed runways is changed, the component 31 is replaced with a component 34 appropriate to this new use, and this is done without modifying the other components. The component 28 is linked to the components 31, 32 and 33, the component 31 being moreover linked to the component 33, while the component 32 is linked to the component 29.

Above the layers 23 and 30 is represented a “project” layer 35 undergoing development, for specific applications. In this example, it comprises: a component 36 for managing radar fire sectors, a component 37 for managing specific runways and a specific navigation management component 38. The components 36 to 38 are respectively linked to the homologous components 33, 31 and 32.

Thus, the structuring library of the invention offers a development process which handles all the various phases necessary for developing an MMI application. By virtue of the fact that the architecture of this library is based on components, the architecture of the application which rests upon this library can be produced in the same way. This architecture of the application can then be regular and of a high level of abstraction. The application can be broken down into sub-applications, then into elementary components. It is possible to establish a clear separation between the interfaces of the latter components and their implementation. It is also possible to delete the code for using the technical services of these components, since the manager 11 takes charge of it. Because each component of the library of the invention is entirely replacable by another specific implementation, the system produced is afforded complete openness.

1. A structuring library based on components for developing man-machine interfaces for command and control information systems comprising:
computer hardware, an operating system, and an execution environment for the development platform, this library comprising, between the execution environment and the specific man-machine interface application, a technical layer grouping together an arrangement of non-specialized technical components in the application domain of said systems, each dedicated to an elementary task, the technical layer forming an assembly of the components providing the nonfunctional services to the application, and an application domain layer grouping together an arrangement of software components of the application domain, the software components forming an assembly providing the functional services to the application, the whole serving as a basis for the MMI application considered.

2. The structuring library as claimed in claim 1, wherein the technical layer comprises, a language extensions layer, a Model component, a Controller component, a View component and a component which bundles together the tools and utilities functions.

3. The structuring library as claimed in claim 1, wherein the domain layer comprises: a layer of types of domains, a Model component, a Controller component, a View component and a component which bundles together the tools and utilities functions.
